(19) United States
(12) Patent Application Publication
(10) Pub. No.: US 2025/0191255 A1
(43) Pub. Date: Jun. 12, 2025

(54) METHOD AND DEVICE WITH MAP BUILDING

(71) Applicant: Samsung Electronics Co., Ltd., Suwon-si (KR)

(72) Inventors: Mengchuan WEI, Beijing (CN); Hui ZHANG, Beijing (CN); Yi ZHOU, Beijing (CN); Byung In YOO, Suwon-si (KR); Seungin PARK, Suwon-si (KR); Sangil JUNG, Suwon-si (KR)

(73) Assignee: Samsung Electronics Co., Ltd., Suwon-si (KR)

(21) Appl. No.: 18/972,349

(22) Filed: Dec. 6, 2024

(30) Foreign Application Priority Data
Dec. 8, 2023 (CN) 202311684793.9
Aug. 6, 2024 (KR) 10-2024-0104380

(51) Int. Cl. G06T 11/20; G06T 11/40

(52) U.S. Cl. CPC G06T 11/203; G06T 11/40; G06T 2210/12

(57) ABSTRACT

Disclosed are a map-building method, a map-building apparatus, an electronic device, and a non-transitory computer-readable storage medium, which relate to the field of artificial intelligence (AI). The map-building method includes generating a heat map based on first curves used to identify a map element of at least one local area and obtaining second curves using an AI network, based on the heat map, in which the second curves are used to identify a map element of the map, and the map-building method transforms a global map-building problem into a collective prediction problem and performs prediction based on image detection using the heat map as an input so that various cases are handled in an integrated manner, and the excessive use of a threshold value is avoided, thereby having excellent versatility.

### CROSS-REFERENCE TO RELATED APPLICATIONS

This application claims the benefit under 35 USC § 119 (a) of Chinese Patent Application No. 202311684793.9, filed on Dec. 8, 2023, in the China National Intellectual Property Administration, and Korean Patent Application No. 10-2024-0104380, filed on Aug. 6, 2024, in the Korean Intellectual Property Office, the entire disclosures of which are incorporated herein by reference for all purposes.

### BACKGROUND

### 1. Field

The following description relates to the field of artificial intelligence (AI), and more particularly, to a map-building method and an electronic device for performing the same, and a non-transitory computer-readable storage medium.

### 2. Description of Related Art

High-definition (HD) maps may be built by predicting a set of vectorized static map elements (e.g., a pedestrian crossing, a lane marking, a road boundary, etc.) under a bird's eye view (BEV). HD maps may be used in the field of autonomous driving and may generally be configured with vectorized representations of instances of map elements. An HD map may provide rich and accurate information about a static environment of a driving scene and may be important for performing downstream tasks such as an autonomous driving system and automatic HD annotation. Two categories of HD maps are global high-definition maps (GHDMs) and a local high-definition maps (LHDMs). A GHDM is generally a long-range map (e.g., a map for distances of tens to hundreds of meters) generated using all pieces of data of one scene (e.g., a sequence of several frames), and an LHDM is generally a close-range map (e.g., a map for a distance of about 60 meters) generally generated using data of a single frame. Vectorized map annotation (VMA) is a technique of representing an HD map in a vector format with annotated vectors (e.g., annotated by object type), and a method of building a global map (e.g., a global HD map) using VMA may building a map by repeatedly fusing local curves using incremental serialization. That is, vectorized mapping for all units may be merged into global vectorized mapping using incremental serialization. Building a global map by using VMA may have low robustness and usability.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of building a map performed by a processor includes generating a heat map based on a plurality of first curves used to identify a map element of at least one local area, the first curves derived from one or more input frames, and obtaining second curves using an artificial intelligence (AI) (neural) network, based on the heat map, the second curves derived from the one or more input frames.

The second curves may be used to identify a map element of the map.

The heat map may include rasterized curves.

The generating of the heat map may include generating the rasterized curves based on coordinate information of points on the plurality of first curves and reliabilities of the respective first curves.

Coordinate information of points on the rasterized curves may be determined based on coordinate information of points at a corresponding position on the plurality of first curves.

Intensity information of the points on the rasterized curves may be determined based on positionally-corresponding reliabilities of the first curves.

The generating of the heat map may further include generating a second area based on coordinate information of points in a first area corresponding to the plurality of first curves and obtaining an average intensity of the rasterized curves based on the rasterized curves and the second area.

Coordinate information of points in the second area may be determined based on coordinate information of points at corresponding positions in the first area.

Intensity information of the points in the second area may be determined based on the number of the points in the first area corresponding to the points in the second area.

The generating of the rasterized curves may include setting, to a preset value, intensity information of points in a bounding box corresponding to the plurality of first curves.

The generating of the rasterized curves may further include transforming coordinates of the points on the plurality of first curves and coordinates of the points in the bounding box into a same coordinate system using a coordinate transformation matrix.

The plurality of first curves may include first-type curves capable of forming a closed area and second-type curves other than the first-type curves.

The generating of the heat map may include generating a first-type heat map by internally filling a portion of the rasterized curves corresponding to the first-type curves.

The generating of the heat map may further include generating a second-type heat map based on a portion of the rasterized curves corresponding to the second-type curves.

The generating of the second-type heat map may include performing a normalization process on average intensities of the respective rasterized curves.

The performing of the normalization process may include performing an expansion process on the portion of the rasterized curves corresponding to the second-type curves.

The obtaining of the second curves may include predicting the first-type curves via a first AI network, based on the first-type heat map, predicting the second-type curves via a second AI/neural network, based on the second-type heat map, and obtaining the second curves based on the predicted first-type curves and the predicted second-type curves.

The obtaining of the second curves may further include determining at least one of the second curves to be a second-type curve based on the second-type heat map.

The predicting of the first-type curves via the first AI/neural network, based on the first-type heat map, may include transforming the first-type heat map into a binarized map, using a threshold value, determining curve-connection areas in the binarized map, extracting a boundary of each of the respective curve-connection areas and determining the boundary to be the first-type curves, calculating average reliabilities of each of the curve-connection areas, and obtaining reliabilities of the first-type curves corresponding to the curve-connection areas by normalizing the average reliabilities of each of the curve-connection areas.

The obtaining of the reliabilities of the first-type curves corresponding to the connection areas by normalizing the average reliabilities of the connection areas may include normalizing the average reliabilities of each of the connection areas, based on a maximum value of the average reliabilities of the connection areas.

The predicting of the second-type curves via the second AI/neural network, based on the second-type heat map, may include extracting a second-type feature from the second-type heat map and predicting and obtaining, coordinate information and reliabilities of the second-type curves of the second curves, using an AI algorithm, based on the second-type feature.

The determining of the at least one second-type curve of the predicted second-type curves to be the second-type curves in the second curves, based on the second-type heat map, may include identifying at least one second-type curve of the predicted second-type curves, which has a similarity with the second-type heat map in a set range, to be the second-type curves in the second curves.

The determining of the at least one second-type curve of the predicted second-type curves, which has the similarity with the second-type heat map in the set range, to be the second-type curves in the second curves may include identifying second-type curves of the predicted second-type curves having the similarity with the second-type heat map greater than or equal to a threshold value, updating the second-type heat map such that an intensity value between a point corresponding to the identified second-type curves in the second-type heat map and a corresponding point in the set range is set to a preset value, continuously executing the identifying of the second-type curves of the predicted second-type curves having the similarity with the second-type heat map greater than or equal to the threshold value until the second-type curves of the predicted second-type curves having the similarity with the second-type heat map in the set range are exhausted.

The identified second-type curves may be the second-type curves in the second curves.

The method may further include determining reliabilities of the second-type curves by normalizing all reliabilities of the identified second-type curves.

In another general aspect, an electronic device includes at least one processor and a memory configured to store instructions, in which, the instructions, when individually or collectively executed by the at least one processor, cause the electronic device to implement any of the methods.

A non-transitory computer-readable storage medium may store instructions that, when executed by a processor, cause the processor to perform any of the methods.

Other features and aspects will be apparent from the following detailed description, the drawings, and the claims.

### BRIEF DESCRIPTION OF THE DRAWINGS

In connection with the description of the drawings, identical or similar reference numerals may be used for identical or similar components.

FIGS. 1A and 1B illustrate examples of a map-building method, according to one or more embodiments.

FIG. 2 illustrates an example of generating a heat map, according to one or more embodiments.

FIG. 3 illustrates an example of first curves and a heat map, according to one or more embodiments.

FIG. 4 illustrates an example of generating second curves, according to one or more embodiments.

FIG. 5 illustrates an example of detecting polygons, according to one or more embodiments.

FIG. 6 illustrates an example of detecting dashed lines, according to one or more embodiments.

FIGS. 7A and 7B illustrate examples of a map-building apparatus, according to one or more embodiments.

FIG. 8 illustrates an example of a heat map generation unit, according to one or more embodiments.

FIG. 9 illustrates an example of a second curve generation unit, according to one or more embodiments.

FIG. 10 illustrates an example of an electronic device, according to one or more embodiments.

FIG. 11 illustrates an example of a non-transitory computer-readable storage medium, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

At least some functions of an apparatus and/or an electronic device may be implemented via an artificial intelligence (AI) model. For example, at least one of several modules of the apparatus and/or the electronic device may be implemented via the AI model. The functions related to AI may be performed by a non-volatile memory, a volatile memory, and a processor.

The processor may include at least one processor. In this case, the at least one processor may be, for example, a general-purpose processor (e.g., a central processing unit (CPU), an application processor (AP), etc.), and/or a graphics-dedicated processing unit (e.g., a graphics processing unit (GPU), a vision processing unit (VPU)), and/or AI-dedicated processor (e.g., a neural processing unit (NPU)).

The at least one processor may control processing of input data according to a predefined operation rule or AI model stored in the non-volatile memory and the volatile memory. The predefined operation rule or AI model may be predefined and provided through training or learning.

Here, providing the predefined operation rule or AI model through learning may involve obtaining a predefined operation rule or AI model with a desired feature by applying a learning algorithm to of pieces of training data. The learning may be performed by the apparatus or the electronic device itself on which the AI model is executed or may be implemented by a separate server, apparatus, or system.

The AI model may include neural network layers. Each neural network layer may perform a neural network calculation by calculating values between input data (e.g., a calculation result of a previous layer and/or input data of the AI model) of a corresponding layer and weights of a current layer. A neural network may include, for example, but is not limited thereto, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network.

The learning algorithm is a method of training a predetermined target device (e.g., a robot) using pieces of training data and of enabling, allowing, or controlling the predetermined target device to perform determination or prediction. The learning algorithm may include, for example, but is not limited thereto, supervised learning, unsupervised learning, semi-supervised learning, or reinforcement learning.

The method according to an example may be related to one or more fields of image technology.

The method according to an example may use image data as input data of the AI model and obtain output data. The AI model may be obtained through training. Here, “being obtained through training” may refer to obtaining the predefined operation rule or AI model with a desired feature (or objective) by training a basic AI model with pieces of training data through the learning algorithm. The method according to an example may relate to the field of visual understanding of AI technology, which is technology for recognizing and processing objects, as in human visual perception, and may include, for example, object recognition, object tracking, image search, human recognition, scenario recognition, three-dimensional (3D) reconstruction/positioning, or image enhancement.

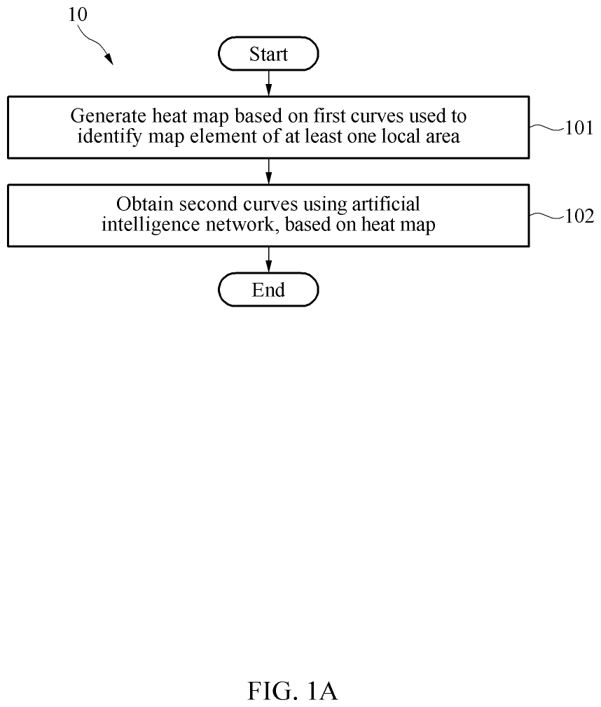

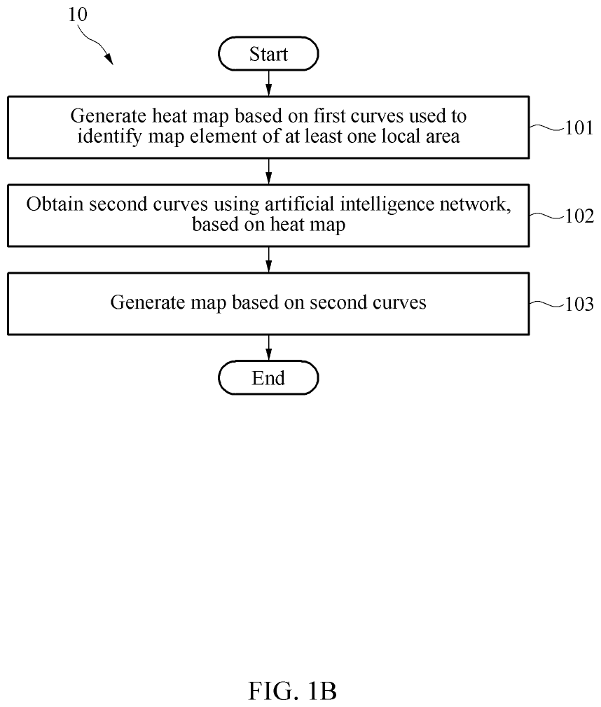

FIGS. 1A and 1B illustrate examples of a map-building method, according to one or more embodiments.

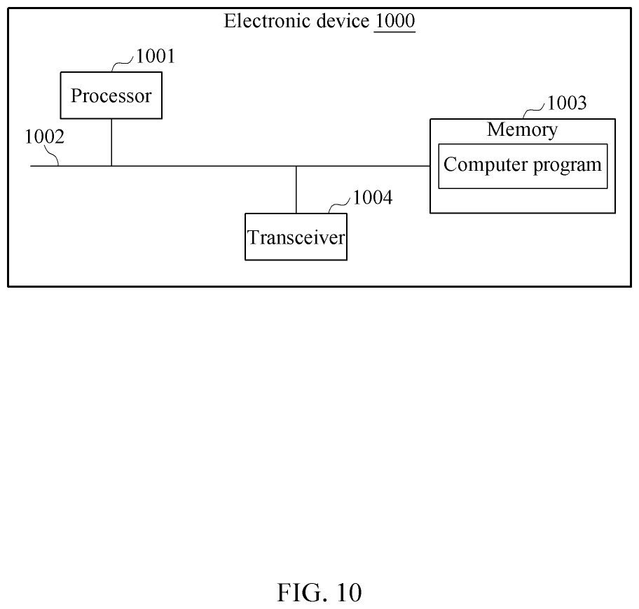

Referring to FIG. 1A, a map-building method 10 may include operations 101 and 102. It may be understood that operations 101 and 102 are performed by a processor (e.g., a processor 1001 of FIG. 10) of an electronic device (e.g., an electronic device 1000 of FIG. 10). The map-building method 10 may have high robustness and versatility by predicting an output using all pieces of information of local curves without repetition.

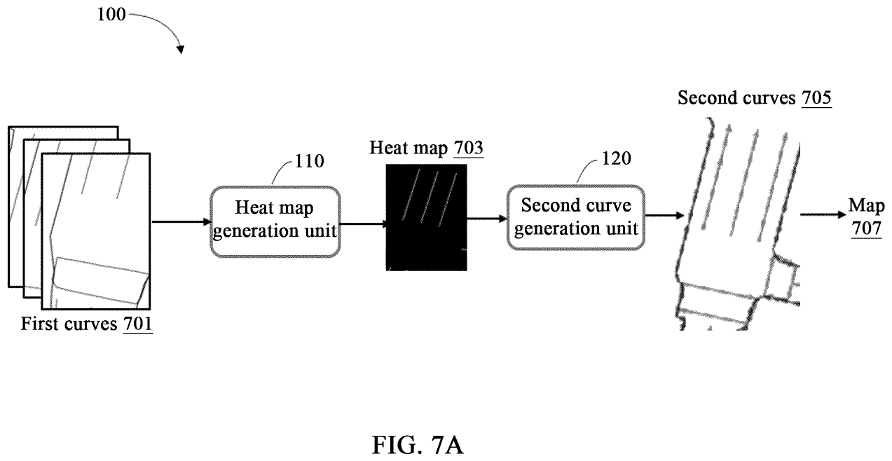

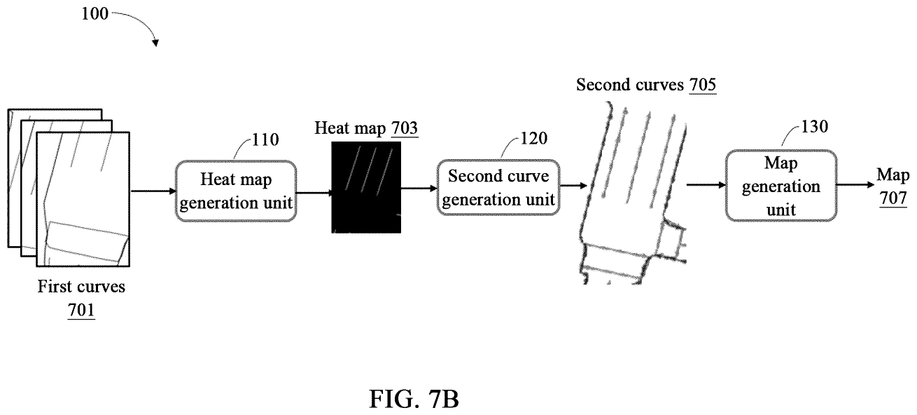

In operation 101, the processor (e.g., the processor 1001 of FIG. 10) may generate a heat map (e.g., a heat map 703 of FIG. 7A) based on first curves (e.g., local curves). The electronic device (e.g., the electronic device 1000 of FIG. 10) performing the map-building method 10 may include at least one processor (e.g., the processor 1001). The first curves may be local curves used to identify a map element of at least one local area in a map to be built.

The first curves (e.g., the local curves) may include an identification line (e.g., road/environment identification) of the map element obtained (i) based on an image (e.g., an environment/local image captured by a camera of a vehicle while the vehicle is driving, etc.) captured by a camera and/or (ii) based on point cloud data (e.g., point cloud data of a surrounding environment detected by laser detection and ranging (LADAR) of a vehicle while the vehicle is driving, etc.). The first curves (e.g., the local curves) may be obtained based on data collected in real time or data collected in the past. The identification line of the map element may identify the map element as being a pedestrian crossing, a lane marking, or a road boundary, as non-limiting examples. A pedestrian crossing identification line may correspond to a point where a pedestrian may safely cross a road, e.g., a crosswalk. A lane marking identification line may correspond to a division of corresponding lanes of a road and may be expressed by various lines, such as a solid line, a dashed line, and a double line; a lane marking line may indicate a usage rule (e.g., whether lane change is possible, no overtaking, etc.) of a corresponding lane. A road boundary identification line may correspond to a division of a road or a boundary of a road and may indicate the width and shape of a corresponding road.

Each of the first curves (e.g., the local curves) may correspond to a single frame of a local image or to multiple frames of the local image. The first curves (e.g., the local curves) may include noise generated during detection/sensing (e.g., detection by a camera and/or a LADAR sensor) and/or image processing, and the reliabilities of the local curves may be the same as or different from each other. A heat map generated based on the first curves (e.g., the local curves) may include coordinate information of points on the first curves (e.g., the local curves) and reliability information of the first curves (e.g., the local curves). For example, all pieces of information obtained through detection/sensing may be used as an input for generating the heat map, and the heat map may be a single-channel image. The local curves extracted corresponding to local images may be used as an input for generating the heat map, or the local images obtained through detection may be used as an input for generating the heat map. Generated second curves (e.g., global curves) may be used as a map for a to-be-built (final-output) map area, for example, for autonomous driving of a smart car.

In operation 102, based on the heat map, the processor may obtain the second curves (e.g., second curves 705 of FIG. 7A) using an AI network. The second curves may be used to identify map elements of the final map. The second curves may be the global curves. The global curves may be generated based on the heat map that includes all pieces of information obtained by detection/sensing. The global/second curves may be obtained using the AI network, based on the heat map. For example, the global curves may be predicted through a method such as machine learning or image detection. The heat map is used as an input for obtaining (e.g., predicting) the second curves (e.g., the global curves), and thus the building of a global map is transformed into a collective prediction problem.

Referring to FIG. 1B, the map-building method 10 may further include operation 103.

In operation 103, the processor 1001 may generate a map (e.g., a map 707 of FIG. 7A) based on the second curves (e.g., the global curves). The generated map may at least include the identification line of the map element in the map area to be built. The processor 1001 may generate a high-definition (HD) map of the map area to be built, based on the second curves (e.g., the global curves) obtained from operation 102. For example, the map area to be built may correspond to a relatively long-distance range (e.g., tens to hundreds of meters). The generated HD map may at least include the identification line of the map element in the map area to be built. The generated HD map may also include other pieces of information that can be used for autonomous driving and/or image labeling. For example, in addition to the global curves, the HD map may include an image of the map element in the map area to be built, such as a photo of a building or a pedestrian path. When the map is built by separately using point coordinates and reliability information of a local map, errors may be accumulated due to incremental processing, resulting in a lack of robustness. For example, directly discarding curves with low reliability may result in insufficient use of information, and repeated merging of curves may result in an incorrect merge correction being impossible before repetition, ultimately resulting in an incorrect merging result. In addition, the design of an algorithm may vary depending on the use case, resulting in a lack of versatility. Specifically, the algorithm may require many patches to handle various boundary conditions, and many tasks of the algorithm may require a threshold value setting, such as alignment, clustering, matching, and merging, resulting in a lack of versatility.

The map-building method 10 may transform the first curves (e.g., the local curves) into the heat map (e.g., the heat map 703 of FIG. 7A) by sufficiently using input information. The heat map may include a coordinate and reliability information of the second curves (e.g., the global curves) to be extracted. The coordinate and the reliability information of the first curves (e.g., the local curves) may be sufficiently and simultaneously used through the heat map, so the map-building method 10 may have high robustness. Since the map-building method 10 transforms the problem of building a global map into a collective prediction problem and performs prediction based on image detection, using the heat map as an input, the map-building method 10 may handle various cases in an integrated manner and avoid the excessive use of a threshold value, and the method 10 thereby has excellent versatility. The heat map may include rasterized curves.

Operation 101 may further include generating the rasterized curves based on coordinate information of points on the first curves and the reliabilities of the respective first curves. In image processing, the rasterized curves may be curves transformed from a vector format into corresponding pixels in a rasterized format. Coordinate information of points on the rasterized curves may be determined based on coordinate information of points at a corresponding position on the first curves, and intensity information of the points on the rasterized curves may be determined based on the coordinate information of the points on the rasterized curves and the reliabilities of the first curves including points of which coordinate information is the same as that of the points on the rasterized curves. For example, the coordinates of the points on the rasterized curves may be determined based on coordinate information of points at a corresponding position on the local curves, and the intensity of the points on the rasterized curves may be a result of processing (e.g., overlapping) the reliabilities of the local curves including points of which coordinate information is the same as that of the points on the rasterized curves. By meshing/merging the local curves, meshed information including an intensity value may be obtained, and the meshed information may be directly used as the heat map or may be used to generate the heat map including all pieces of input information through further processing.

Operation 101 may further include generating a second area based on coordinate information of points in a first area corresponding to the first curves and obtaining average intensity of the rasterized curves based on the rasterized curves and the second area. The first area may include a detection area corresponding to the local curves. Coordinate information of points in the second area may be determined based on coordinate information of the points at a corresponding position in the first area. Intensity information of the points in the second area may be determined based on the number of points in the first area corresponding to the points in the second area. The first curves (e.g., the local curves) obtained by detection may have a large amount of overlap in the detection area (e.g., the first area) to which the first curves belong. The processor 1001 may coordinate the detection area to accurately use reliability information (e.g., reliability information of the first curves) and process an intensity value of the rasterized curves according to the number of overlapping coverages of the detection area.

The processor 1001 may transform the first curves (e.g., the local curves) and the coordinates of the points in the first area into the same coordinate system, using a coordinate transformation matrix, before based on the coordinates of the points on the first curves (e.g., the local curves) and the reliability of each of the first curves (e.g., the local curves). The local image of the plurality of detected frames may generally have an independent coordinate system, and the processor 1001 may transform the coordinates of the first curves (e.g., the local curves) extracted from the local image of the plurality of frames into the same coordinate system through coordinate transformation. For example, the processor 1001 may transform the coordinates of the first curves into a coordinate system of a local image of a 0th frame and facilitate subsequent processing for generating the heat map. The detection area corresponding to the local image of the plurality of frames may also have an independent coordinate system, and the processor 1001 may also transform the coordinate of the detection area corresponding to the local image of the plurality of frames into the same coordinate system through coordinate transformation.

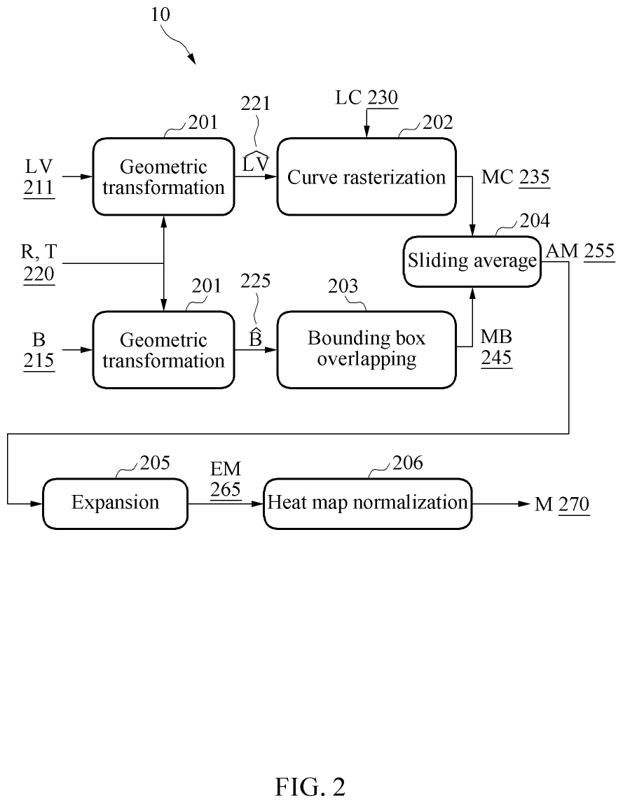

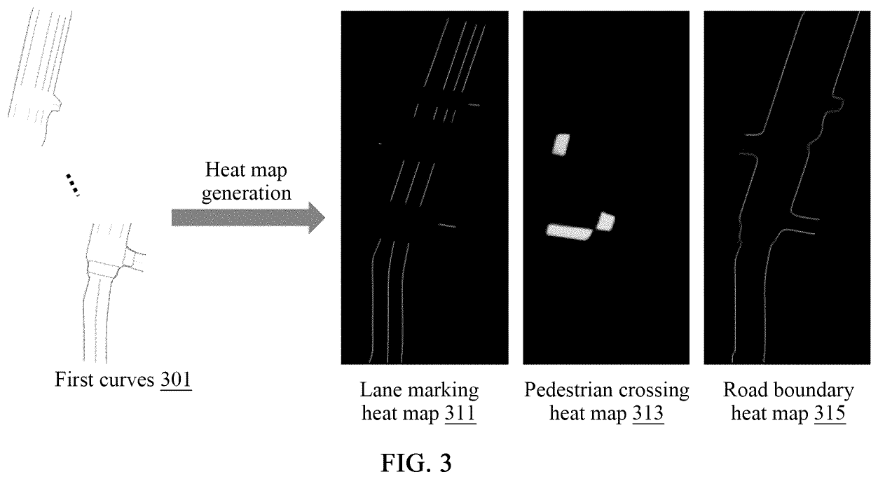

FIG. 2 illustrates an example of generating a heat map, and FIG. 3 illustrates an example of first curves and a heat map, according to one or more embodiments.

Referring to FIGS. 2 and 3, the map-building method 10 performed by a processor (e.g., the processor 1001 of FIG. 10) may further include operations 201 to 206. It may be understood that operations 201 to 206 are performed by the processor (e.g., the processor 1001 of FIG. 10) of an electronic device (e.g., the electronic device 1000 of FIG. 10).

In operation 201, the processor 1001 may perform geometric transformation. The geometric transformation may include transforming coordinates of points on first curves (e.g., local curves) and coordinate of points in a bounding box corresponding to the first curves (e.g., the local curves) into the same coordinate system, using a coordinate transformation matrix. For example, LV 211 represents an arbitrary coordinate of a point on the local curves, B 215 represents an arbitrary coordinate of a point in the bounding box corresponding to the local curves, and R, T 220 represent arbitrary coordinate transformation matrices, specifically a rotational geometric transformation matrix and a translational geometric transformation matrix, respectively. The processor 1001 may use a coordinate transformation matrix R and a coordinate transformation vector T (e.g., the R, T 220) and transform the LV 211 and the B 215 into the same coordinate system (e.g., a coordinate system of a 0th frame), thereby obtaining transformed first-curve and bounding coordinates [symbol] 221 and \hat{B} 225. For example, when the processor 1001 transforms the LV 211 and the B 215 into the coordinate system of a 0th frame, the processor 1001 may transform the coordinates of the local curves of each corresponding frame (e.g., a t-th frame) and the points in the bounding box of the local curves from a coordinate system of the corresponding frame (e.g., the t-th frame) to the coordinate system of the 0th frame, using coordinate transformation matrices R^{t→0} and T^{t→0}.

In operation 202, the processor 1001 may perform curve rasterization. The processor 1001 may perform coordinate transformation on the coordinate (e.g., the LV 211, representative of many points) of the point on the first curves (e.g., the local curves) and may then generate rasterized curves based on the transformed coordinates of the points on the first curves (e.g., the local curves) and the reliabilities of each of the first curves (e.g., the local curves). Coordinates of points on the rasterized curves may be determined based on coordinate information of points at a corresponding position on the first curves (e.g., the local curves). For example, the points on the rasterized curves may include points on/from all local curves. Intensity information of the points on the rasterized curves may be determined based on the coordinate information of the points on the rasterized curves (i.e., based on their raster locations) and the reliability of a first curve (e.g., a local curve) including points of-which coordinate information is the same as that of the points on the rasterized curves. The intensity information of the points on the rasterized curves may be determined based on the overlap/commonality of reliabilities of the first curves (e.g., the local curves) for the points on the rasterized curves. For example, LC 230 represents the reliabilities of the local curves and may be an input for performing curve rasterization. The processor 1001 may perform curve rasterization, using the transformed curve coordinates [symbol] 221 and the reliabilities LC 230 as inputs, and rasterize and overlap (union) the local curves. The intensities of the raster points (e.g., the intensity information of the points on the rasterized curves) may vary depending on the reliabilities of the first curves (e.g., the local curves), and finally, MC 235 (MC∈R^{H*W}), which is a single-channel image (e.g., a grayscale image) of the rasterized curves may be generated; H and W being the height and the width of the image of rasterized curves, respectively.

The curve rasterization (e.g., operation 202) performed by the processor 1001 may obtain a grayscale image, such as the image MC 235, which is an image of rasterized curves, based on a coordinate set of the points of the first curves (e.g., the local curves) and their reliabilities. Selectively, various strategies may be used to rasterize a dashed line and a polygon (recall, a dashed line is a common type of road marking). For example, an edge (e.g., a boundary) of the dashed line may be rasterized with the following three stages.

Initialization: Initialize the image MC 235 to 0.

Dichotomization: Calculate pixel positions of all local curves of the MC 235 image.

Rendering: Render edges of all local curves using the reliabilities of the local curves as the intensities of the MC 235 (i.e., points in MC 235 reflect reliabilities of corresponding local curves). Pixel values transmitted from dashed lines may be the same as the sum of values of the dashed lines at a corresponding pixel.

For example, an inner area of the polygon may be rasterized through the following three stages.

Initialization: Initialize the image MC 235 to 0.

Dichotomization: Calculate pixel positions of all local curves of the image MC 235.

Rendering: Fill polygon areas (areas enclosed by the local curves) of the MC 235 using the reliabilities as the intensity of the polygon areas in the image MC 235. Values of pixels in the polygons may be the same as the sum of values of the polygons at a corresponding pixel.

In operation 203 of forming a rasterized bounding box image MB 245, the processor 1001 may perform bounding box overlapping from the bounding box points B 215. The overlapping of the bounding boxes may include rasterization of the bounding boxes. A first area may be obtained by a bounding box of the first curves. For example, the processor 1001 may generate the first area by setting, to a preset value (e.g., 1), intensity information of points in the bounding box corresponding to the coordinate-transformed first curves and filling the bounding box accordingly. The processor 1001 may generate a second area based on the filled bounding box. Coordinate information of points in the second area may be determined based on coordinate information of points at a corresponding position in the first area. For example, the coordinate information of the points in the second area may be coordinates of the points at the corresponding position in the first area. Intensity information of the points in the second area may be determined based on the number of points in the first area corresponding to the points in the second area. For example, when the intensity information of the points in the bounding box is set to 1, the number of points (e.g., the number of points in the first area) may be the sum of pieces of intensity information of the first area that matches a corresponding point (e.g., a \hat{B} point in the bounding box). For example, when an input is the transformed bounding box(es) 225, all the bounding boxes may be filled and overlapped so that MB 245 (MB∈R^{H*W}), which is a single channel image, may be generated. Here, H and W represent the height and the width of the rasterized bounding box (e.g., the MB 245), respectively. For example, the height and the width of the rasterized bounding box MB 245 may be determined to have the same dimensions as the MC 235, which is a rasterized curve. A pixel value (e.g., intensity of rasterization) of the MB 245, which is an image, may represent how much the bounding box of a frame covers a corresponding position (e.g., a position of the bounding box).

The rasterization of the bounding box (e.g., bounding box overlapping (e.g., operation 203)) performed by the processor 1001 may include obtaining the MB 245, which is a grayscale image (e.g., the second area), based on the \hat{B} 225, which is a transformed bounding box variable of all frames being processed. Selectively, the rasterization of the bounding box may include the following.

Initialization: Initialize the MB 245, which is the second area, to 0.

Dichotomization: Calculate a pixel position of the \hat{B} 225, which is the transformed bounding box variable of all frames, in the MB 245.

Rendering: The MB 245, which is the second area, may be obtained by rendering the intensity of the transformed bounding box to 1 (for example, by setting the intensity or pixel value of the point in the bounding box to 1). The values of the pixels covered by bounding boxes may be the same as the sum of the number of first areas at a corresponding pixel.

In operation 204, the processor 1001 may perform a sliding average. The processor 1001 may obtain average intensity of the rasterized curves based on the rasterized curves and the second area. Selectively, the average intensity of the rasterized curves may include an average of overlapping reliabilities, based on the number of occurrences of the first area (e.g., the intensity or pixel value corresponding to the second area). When points (e.g., points appearing in the local curves) of local images (corresponding to the local curves) of the frames are at the same coordinate, a pixel value of a corresponding coordinate, that is, the overlap of the reliabilities of the local curves corresponding to points appearing in the corresponding coordinate may need to follow the number of detections. When the bounding box (e.g., the first area) of the frames appears at the corresponding coordinate, the overlap of the reliabilities may need to be averaged according to the number of times the bounding box appears. To perform the sliding average (e.g., operation 204), the processor 1001 may use the MC 235 and the MB 245 as inputs and output an

$$AM 255 ( AM = \frac{MC}{MB} ∈ {R}^{H * W} ) ,$$

which is an average heat map. The average processing may be performed only in the area of the bounding box.

The performing of the sliding average (e.g., operation 204) of the rasterized curves may include inputting the two grayscale images, the MC 255 (MC∈R^{H*W}) and the MB 245 (MC∈R^{H*W}), and outputting the

$$AM 255 ( AM = \frac{MB}{MC} ∈ {R}^{H * W} ) ,$$

which is a grayscale image. Here, the AM 255 may be as follows.

$$AM [ h , w ] = \{ \begin{matrix}0 , & MB [ h , w ] = 0 \\ \frac{MC [ h , w ]}{MB [ h , w ]} , & etc .\end{matrix}$$

Here h∈{0, 1, . . . , H−1}, w∈{0, 1, . . . , W−1}.

In operation 206, the processor 1001 may perform heat map normalization. The processor 1001 may obtain a heat map by normalizing average intensity. A normalized heat map 270 (M∈R^{H*W}) may be output. The first curves may include first-type curves (e.g., polygonal areas) capable of forming a closed area and second-type curves (e.g., dashed lines corresponding to dashed road-lines) other than the first-type curves (i.e., not forming closed areas).

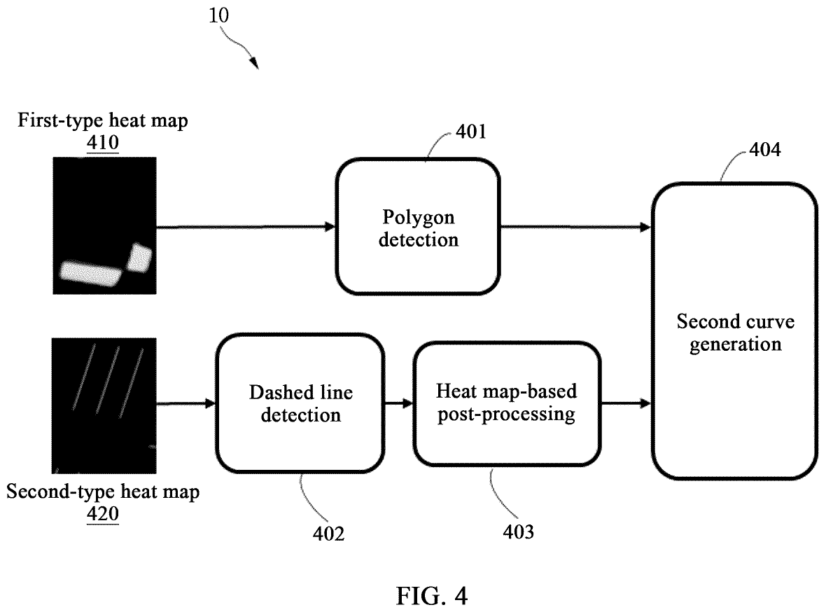

The map-building method 10 may further include generating a first-type heat map (e.g., a first-type heat map 410 of FIG. 4) by internally filling the portion of the rasterized that are the first-type curves (e.g., the polygonal areas). The first-type heat map may be a polygonal-type heat map. For example, a filling value in the polygonal areas may be determined based on the reliability of a corresponding first curve (e.g., a local curve). The map-building method 10 may further include generating a second-type heat map (e.g., a second-type heat map 420 of FIG. 4) based on the portion of the rasterized curves that are the second-type curves (e.g., the dashed lines). The second-type heat map may be a dashed line-type heat map. For example, in the dashed line type, an edge may be rendered (for example, a pixel value of points on the dashed lines may be set) based on the reliability of the corresponding first curve (e.g., the local curve). When the dashed lines of the first curves (e.g., the local curves) overlap, a pixel value of the overlapping portion may be the set to be the sum of pixel values of points of the corresponding dashed lines. Selectively, normalization may be performed only on the second-type heat map (e.g., the dashed line-type heat map). The generating of the second-type heat map may include normalizing the average intensity of each of the rasterized curves. The normalization process may include a process of calculating an average and standard deviation of all heat maps only for valid pixels (e.g., pixels other than 0) and normalizing each heat map of all pixels by the average and standard deviation.

Referring to FIG. 3, an input used for generating a heat map may be obtained from first curves 301 of all frames (currently being processed) including a lane marking, a pedestrian crossing, and/or a road boundary, for example. The generated heat map may include a lane marking heat map 311, a pedestrian crossing heat map 313, and a road boundary heat map 315. The insides of the polygon curves of the pedestrian crossing heat map 313 may already be filled. Referring back to FIG. 2, the map-building method 10 may further include operation 205.

In operation 205, the processor 1001 may perform expansion. The processor 1001 may expand a dashed line (fill the empty parts) of the second-type heat map (e.g., the second-type heat map 420 and the dashed line-type heat map of FIG. 4). The second-type heat map may be a dashed line-type heat map. For example, the processor 1001 may thicken the dashed line in the dashed line-type heat map. The AM 255, which is an average heat map, may be expanded through a Gaussian kernel, and the processor 1001 may obtain an expanded heat map 265 (EM∈R^{H*W}). The generating of the second-type heat map may include normalizing (e.g., operation 206) the average intensity of the rasterized curves (e.g., the MC 235) for each of the rasterized curves (e.g., the MC 235). The normalizing (e.g., operation 206) of the average intensity may include expanding (e.g., operation 205) a portion of the rasterized curves corresponding to the second-type curves. The AM 255, which is an average heat map, may be expanded (converted from dashed lines to solid lines) using a Gaussian kernel. The processor 1001 may obtain the expanded heat map 265 (EM∈R^{H*W}) in which the AM 255, which is an average heat map, is expanded.

The expanding (e.g., operation 205) of the dashed line in the second-type heat map (e.g., the second-type heat map 420 and the dashed line-type heat map of FIG. 4) by the processor 1001 may include inputting an image I∈R^{H×W} and a Gaussian kernel K∈R^{K×k} and outputting an expanded image E∈R^{H×W}. Here, E=∈(I, K),

$$E [ h , w ] = {\sum }_{x = - p}^{p} {\sum }_{y = - p}^{p} K [ x + p , y + p ] \cdot I [ h + x , w + y ] , p = ⌊ k / 2 ⌋$$

$$and , h ∈ \{ p , … , H - p - 1 \} , w ∈ \{ p , … , W - p - 1 \} .$$

In the map-building method 10, operation 102 may further include predicting the first-type curves via a first AI network, based on the first-type heat map, predicting the second-type curves via a second AI network (based on the second-type heat map), and obtaining the second curves based on the predicted first-type curves and the predicted second-type curves. For example, the second curves may be obtained by combining the first-type curves with the second-type curves, based on coordinates of the first-type curves and the second-type curves.

FIG. 4 illustrates an example of generating second curves, according to one or more embodiments.

Referring to FIG. 4, the map-building method 10 may further include operations 401 to 404. It may be understood that operations 401 to 404 are performed by a processor (e.g., the processor 1001 of FIG. 10) of an electronic device (e.g., the electronic device 1000 of FIG. 10).

In operation 401, the processor (e.g., the processor 1001 of FIG. 10) may perform polygon detection. The processor 1001 may predict a polygonal area of second curves (e.g., global curves), based on the first-type heat map 410 (e.g., a polygon-type heat map). The polygonal area of the second curves (e.g., the global curves) may be output when the first-type heat map 410 (e.g., the polygon-type heat map) is input and the processor 1001 performs polygon detection.

In operation 402, the processor 1001 may perform dashed line detection. The processor 1001 may predict a dashed line of the second curves (e.g., the global curves), based on the second-type heat map 420 (e.g., a dashed line-type heat map). The dashed line of the second curves (e.g., the global curves) may be output when the second-type heat map 420 (e.g., the dashed line-type heat map) is input and the processor 1001 performs dashed line detection.

Selectively (optionally), the processor 1001 may perform operation 403. In operation 403, the processor 1001 may select one or more dashed lines from among the dashed lines predicted based on the second-type heat map 420 (e.g., the dashed line-type heat map), and may determine the one or more dashed lines to be second-type curve(s) to be included in the overall set of second curves (e.g., the global curves). That is, the processor 1001 may obtain a more accurate result by performing post-processing on the predicted dashed lines.

In operation 404, the processor 1001 may generate the second curves (e.g., the global curves). The processor 1001 may generate the second curves (e.g., the global curves) based on the polygonal area(s) and the selected dashed line(s) (e.g., the one or more dashed lines selected from among the predicted dashed lines). For example, the processor 1001 may obtain the global curves by combining the polygonal area with the dashed line, based on the coordinates of the polygonal area and the dashed line (e.g., the selected dashed line(s)).

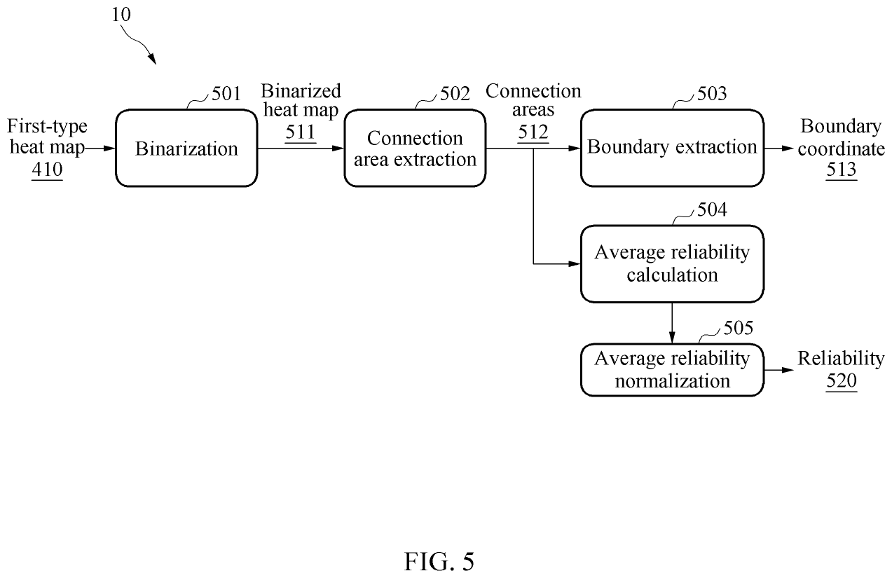

FIG. 5 illustrates an example of detecting polygons, according to one or more embodiments.

Referring to FIG. 5, in the map-building method 10, operation 401 described above with reference to FIG. 4 may further include operations 501 to 505. It may be understood that operations 501 to 505 are performed by a processor (e.g., the processor 1001 of FIG. 10) of an electronic device (e.g., the electronic device 1000 of FIG. 10).

In operation 501, the processor 1001 may perform binarization. The processor 1001 may transform the first-type heat map 410 (e.g., a polygon-type heat map) into a binarized heat map 511, using a threshold value. For example, the processor 1001 may binarize the polygon-type heat map, using a threshold value of 0.4. The processor 1001 may obtain a binarized map (e.g., the binarized heat map 511).

In operation 502, the processor 1001 may perform connection area extraction. The processor 1001 may determine connection areas 512 in the binarized map (e.g., the binarized heat map 511). For example, the processor 1001 may extract the connection areas 512 from the binarized heat map 511, using a connection area extraction algorithm.

In operation 503, the processor 1001 may perform boundary extraction. The processor 1001 may extract a boundary of each of the connection areas 512 and determine the boundary to be the polygonal area. The outline of each of the connection areas 512 may be a boundary coordinate 513 of at least one polygonal area. The processor 1001 may perform the boundary extraction and obtain the boundary coordinate 513 from the connection areas 512.

In operation 504, the processor 1001 may perform an average reliability calculation. The processor 1001 may calculate the average reliability of each of the connection areas 512. An average value of pixels in the connection areas 512 may be used as the reliability for the polygonal area of the second curves (e.g., the global curves). The processor 1001 may perform the average reliability calculation and output the average reliability.

In operation 505, the processor 1001 may perform average reliability normalization. The processor 1001 may normalize the average reliability of each of the connection areas 512. Selectively, the maximum value of the reliabilities may be 1, and other reliabilities may be adjusted based on a ratio to the maximum value of the reliabilities. For example, the normalizing of the average reliability for each of the connection areas 512 may include normalizing the average reliability for each of the connection areas 512 based on the maximum value of the average reliabilities of the connection areas 512. The processor 1001 may obtain reliabilities 520. The calculated reliabilities 520 (normalized or not) may be the reliabilities of the respective first-type curves.

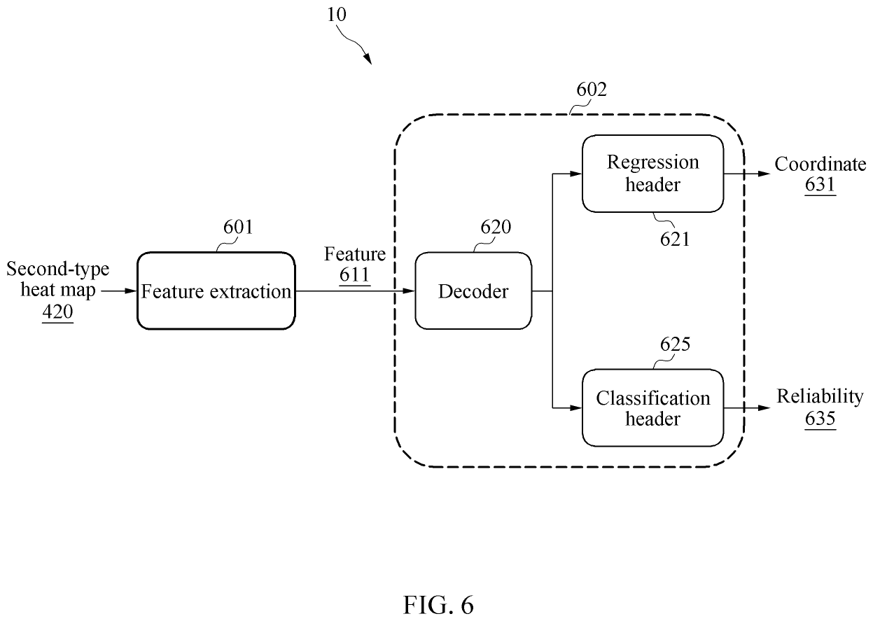

FIG. 6 illustrates an example of detecting dashed lines, according to one or more embodiments.

Referring to FIG. 6, in the map-building method 10, operation 402 described above with reference to FIG. 4 may further include operations 601 and 602. It may be understood that operations 601 and 602 are performed by a processor (e.g., the processor 1001 of FIG. 10) of an electronic device (e.g., the electronic device 1000 of FIG. 10).

In operation 601, the processor 1001 may extract dashed line features from the second-type heat map 420 (e.g., the dashed line-type heat map). For example, the processor 1001 may extract features from the dashed line-type heat map, using ResNet50+FPN. A residual network (ResNet) is a neural network structure used in the field of image recognition, and ResNet50 may be a ResNet model having 50 layers, for example. A feature pyramid network (FPN) may be used to improve object detection performance by providing the ability to generate feature maps of varying sizes (i.e., different map resolutions of the same underlying feature data).

In operation 602, the processor 1001 may predict coordinates 631 and reliabilities 635 of dashed lines, by applying a mapping transformer (MapTR) algorithm to the extracted features 611. A MapTR is a transformation-based neural network model and may have high performance in a sequence transformation task. The processor 1001 may optimize a predetermined query Q to predict the dashed lines, and may do so using a decoder 620 (e.g., a MapTR decoder). For example, the decoder 620 (e.g., the MapTR decoder) may include a set of decoder layers that repeatedly updates the query Q. Here, an initial value of the query Q is a part of a detection parameter obtained by training and may represent common property of the second curves (e.g., the global curves). The decoder 620 may continuously optimize the query Q by internally performing an operation (e.g., an attention mechanism, a linear operation, and an operation such as SoftMax) between the initial query Q and the feature(s) 611 obtained by feature extraction (e.g., operation 601) and finally output the optimized query Q. The processor 1001 may predict the coordinates of the second curves (e.g., the global curves) from the query Q, using a regression header 621 of the MapTR algorithm. The processor 1001 may predict the reliabilities of the second curves (e.g., the global curves) from the query Q, using a single-class classification header of the MapTR algorithm. A training process of a MapTR model may include obtaining a training dataset, augmenting training data, and optimizing training loss. The training dataset used to train the MapTR model may be a set of heat maps. To obtain the training dataset, a NuScenes training dataset may first be input to one MapTR model, and the local curves obtained through inference may be transformed into a heat map by a heat map generator. NuScenes is a large-scale dataset for autonomous vehicles and may include a variety of sensor data. Tasks may be performed separately on each of local types, and finally, a total of n (e.g., n may be 1,400) training samples (e.g., training datasets) may be generated. For example, since there are 700 scenarios in the NuScenes training dataset and the number of types of local curves is 2 (lane marking and road boundary), 700*2=1,400 training samples may be generated. In the training of the MapTR model, when data (e.g., the training dataset) is augmented, a problem of insufficient training data may be alleviated using a data augmentation technique. For example, a data augmentation technique including random transformation, random rotation, and random flipping may be used. When training loss is being optimized, the processor 1001 may follow a MapTR model training loss function, which includes three parts, including classification loss [symbol] _{cls}, point-to-point loss [symbol] ₚ₂ₚ, and edge direction loss [symbol] _{dir}. When these loss terms are combined, the overall objective function (i.e., a loss function) may be expressed as follows.

$$ℒ = {λ}_{1} {ℒ}_{cls} + {λ}_{2} {ℒ}_{p 2 p} + {λ}_{3} {ℒ}_{dir}$$

Here, λ₁, λ₂, and λ₃ denote hyperparameters used to balance each loss term.

In the process of training the MapTR model based on the training dataset, the objective function may be minimized by continuously adjusting a parameter of the MapTR model (e.g., weight) according to changes in the objective function (e.g., the loss function), and finally, a trained MapTR model may be obtained.

In the map-building method 10, operation 403 described above with reference to FIG. 4 may further include determining second-type curves, among the predicted second-type curves, that have respective similarities with the second-type heat map 420 within a set range to be the second-type curves in the second curves.

In the map-building method 10, operation 403 (heat map-based post-processing) may include determining second-type curves (e.g., dashed lines), among the predicted second-type curves, that have respective similarities with the second-type heat map 420 greater than or equal to a threshold value. Operation 403 may include updating the second-type heat map 420 such that intensity values of points corresponding to the determined second-type curves in the second-type heat map 420 (e.g., the dashed line-type heat map) and corresponding points in the set range are set to a preset value. Operation 403 may further include continuously executing the determining of the second-type curves of the second-type curves having the similarities with the second-type heat map 420 greater than or equal to the threshold value until the second-type curves of the predicted second-type curves having the similarity with the second-type heat map 420 in the set range does not exist. The determined second-type curves may be the second-type curve in the second curves. The determining of the second-type curves to be the second-type curve in the second curves may be implemented by operations 1 to 6 described below.

In operation 1, in the second-type curves (e.g., the dashed lines), the processor 1001 may determine a second-type curve of the predicted second-type curves (e.g., the predicted dashed lines), which has a similarity with the second-type heat map 420 (e.g., the dashed line-type heat map) greater than or equal to the threshold value. For example, the processor 1001 may search for the first dashed line, among the dashed lines of the predicted global curves, which has the strongest match (e.g., a similarity that is greater than or equal to the threshold value) with the dashed line-type heat map. The first dashed line may be the determined second-type curve and may be the second-type curve (e.g., the dashed line) having a similarity with the second-type heat map 420 greater than or equal to the threshold value.

In operation 2, the processor 1001 may update the second-type heat map 420 (e.g., the dashed line-type heat map) such that an intensity value of points corresponding to the determined second-type curve of operation 1 (e.g., the first dashed line) and the corresponding points in the set range is set to a preset value. For example, in the dashed line-type heat map, the processor 1001 may update the dashed line-type heat map such that an intensity value of points corresponding to the first dashed lines and corresponding points in the set range is set to a preset value of 0. The processor 1001 may repeat operations 1 and 2 until the second-type curve of the predicted second-type curve of which the similarity with the second-type heat map is in the set range does not exist (i.e., there are no more of). Optionally, the processor 1001 may normalize the reliabilities of all selected second-type curves.

In the map-building method 10, operation 403 may further include operations 3 to 6 in addition to operations 1 and 2.

In operation 3, the processor 1001 may add a coordinate and reliability of the first dashed line to a dashed line list.

In operation 4, the processor 1001 may remove the first dashed line from a dashed line portion of the predicted second curves (e.g., the global curves).

In operation 5, the processor 1001 may return to operation 1 and continue operations 1 to 5.

In operation 6, when the first dashed line is not searched for in operation 1, the processor 1001 may normalize the reliabilities of all dashed lines in the dashed line list, determine the dashed lines in the dashed line list to be the dashed lines of the global curves, and determine the normalized reliabilities to be the reliabilities of the dashed lines of the global curves.

The reliability of the first dashed line may be obtained by calculating the similarity between the first dashed line and the second-type heat map (e.g., the dashed line-type heat map). For example, the similarity may be an average value of the dashed line-type heat map in an area enclosed by a bounding box. When the second-type heat map (e.g., the dashed line-type heat map) is M and a curve coordinate of the second-type heat map (e.g., the dashed line-type heat map) is GV′, the removing of an incorrect curve from the second-type heat map (e.g., the dashed line-type heat map) may include the following stages 1 to 7.
Stage 1: Initialize G to an empty list.
Stage 2: Search for GV′_{\hat{n}}, which is a curve that best matches Min GV′, and when the search is not possible, proceed to stage 7.
Stage 3: Update M and set, to 0, a pixel near GV′_{\hat{n}} in M. Here, a range of the pixels set to 0 may be determined based on the same algorithm as the expansion algorithm in operation 205 described above with reference to FIG. 2. That is, the nearby pixel may be set to 0 based on the range including the expanded curve.
Stage 4: Add GV′_{\hat{n}}, GC′_{\hat{n}} to G. Here, GC′_{\hat{n}} represents the reliability and may be determined based on the similarity between GV′_{\hat{n}} and M.
Stage 5: Update GV′ and remove GV′_{\hat{n}} from GV′.
Stage 6: Return to stage 2 and search for more matching curves.
Stage 7: Normalize the reliabilities of all curves in G, determine the dashed line in the list to be the reliability of the dashed line of the global curves, and determine the normalized reliability to be the reliability of the dashed line of the global curves.

FIGS. 7A and 7B illustrate examples of a map-building apparatus, according to one or more embodiments.

Referring to FIGS. 7A and 7B, a map-building apparatus 100 (e.g., the electronic device 1000 of FIG. 10) may include a heat map generation unit 110 and a second curve generation unit 120. The map-building apparatus 100 may perform the map-building method 10 described above with reference to FIGS. 1 to 6. The heat map generation unit 110 may be configured to generate the heat map 703 based on first curves 701. A first curve (e.g., at least one of the first curves 701) may be used to identify a map element of at least one local area in a map (e.g., the map 707) to be built. The first curves 701 may be local curves. The second curve generation unit 120 may be configured to obtain the second curves 705 using an AI network, based on the heat map 703. The second curves 705 may be used to identify a map element of the map (e.g., the map 707) to be built. The second curves may be global curves.

The first curves 701, which are pieces of input data of the map-building apparatus 100, may include a coordinate LV∈R^{N×P×2} (e.g., the LV 211 of FIG. 2) of a local curve of each of frames in one scene. Here, N denotes the number of curves, P denotes the number of points of each curve, and 2 denotes two-dimensional x and y coordinates. The input data of the map-building apparatus 100 may be a first curve l={Lᵢ^{t}|t∈{0, 1, . . . , t−1}, i∈{0, 1, 2}} (e.g., the local curve) and may be the prediction of a local map curve by a local map-building model of all frames. For example, the first curve (e.g., the local curve) may be obtained using a MapTR, which is a local map generation model of a NuScenes val set.

Here, t denotes a frame number, i∈{0, 1, 2} denotes the classification of the map elements (e.g., 0 may represent a lane marking, 1 may represent a pedestrian crossing, and 2 may represent a road boundary), and Lᵢ^{t}=(LVᵢ^{t}, LCᵢ^{t}) denotes a local curve of an i-th type in a t-th frame.

LVᵢ^{t} I∈R^{N}^{ᵢ}^{^{t}}^{×P×2} denotes a coordinate of a point on the local curve of the i-th type in the t-th frame, in which Nᵢ^{t} denotes the number of local curves of the i-th type in the t-th frame, P denotes the number of points on each of the local curves, and 2 denotes a 2D coordinate.

The map-building apparatus 100 may transform coordinates of points on the first curves 701 and coordinates of points in a bounding box into the same coordinate system (e.g., a coordinate system of a 0th frame), using a coordinate transformation matrix R. Coordinate transformation matrices for 2D rigid body coordinate transformation from each frame to the 0th frame may be R and T, and a coordinate bounding box of the local curve of each of the frames may be B=[xmin, xmax, ymin, ymax]. A bounding box of the local curve of the t-th frame may be Bₜ=[xmin, xmax, ymin, ymax]=[−15, 15,−30, 30], which may be the bounding box of the local curve and have a meter as a unit. When the 0th frame is selected as a universal coordinate system, R and T, which are pieces of input data for coordinate transformation, may be as follows.

R^{t→0}: A 2D rotation matrix from a coordinate system t (e.g., the coordinate system of the t-th frame) to a coordinate system 0.

T^{t→0}: A 2D translation vector from the coordinate system t (e.g., the coordinate system of the t-th frame) to the coordinate system 0.

The map 707, which is output data of the map-building apparatus 100, may include a coordinate GV={GVₙ∈R^{P}^{ₙ}^{×2}|n=0, 1, N−1} and reliability GC∈R^{N} of a global curve in one scene. An example in which the map-building apparatus 100 uses the extracted local curve data (e.g., data such as the coordinates of the points on the local curves and reliability) as input data and generates heat map data (e.g., the heat map 703) through processing by directly using a local image of frames obtained by detection as input data is also apparent. G={(GVᵢ, GCᵢ)|i=0, 1, 2} denotes a global curve, GVᵢ={GV_{i,n}∈R^{P}^{_{i,n}}^{×2}|n=0, 1, Nᵢ−1} denotes a coordinate of a point on a predicted global curve, and GCᵢ∈R^{N}^{ᵢ} denotes a reliability score of a predicted global map element. Here, Nᵢ denotes the number of curves of the i-th type and P_{i,n} denotes the number of points on an n-th curve of the i-th type.

Referring to FIG. 7B, the map-building apparatus 100 may further include a map generation unit 130. The map generation unit 130 may be configured to generate the map 707 (e.g., a finally outputted HD map) in a predetermined area, based on the second curves 705 (e.g., the global curves), and the map 707 may at least display a map element identification line in the predetermined area. It should be noted that the HD map may include any pieces of information useful for autonomous driving or image labeling and is not limited to the components described herein. At least one first curve (e.g., local curve) of the first curves 701 may correspond to at least a portion of the map element identification line of a local image of at least one frame in the predetermined area.

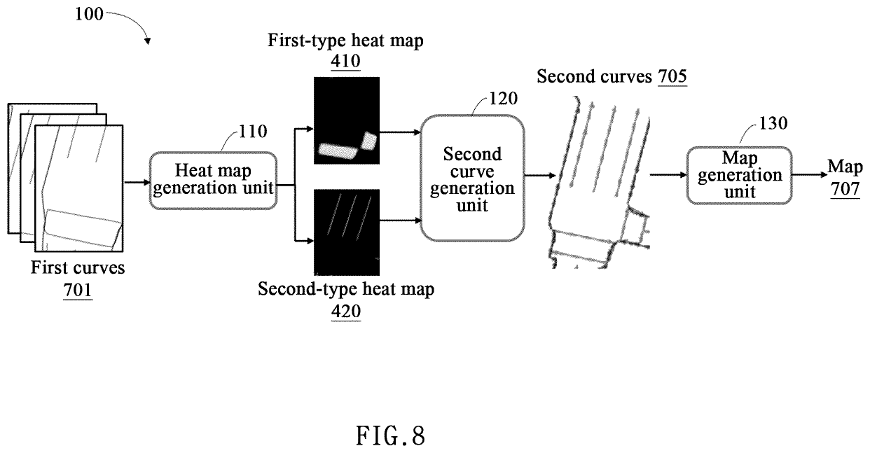

FIG. 8 illustrates an example of a heat map generation unit, according to one or more embodiments.

Referring to FIG. 8, the heat map generation unit 110 of the map-building apparatus 100 may be configured to generate rasterized curves, based on coordinate information of points on the first curves 701 and reliabilities of the respective first curves 701. Coordinate information of points on the rasterized curves may be determined based on coordinate information of points at a corresponding position on the first curves 701, and intensity information of the points on the rasterized curves may be determined based on the reliability of a first curve including points of which coordinate information is the same as that of the points on the rasterized curves. The heat map generation unit 110 may generate a second area based on coordinate information of points in a first area corresponding to the first curves 701. Coordinate information of points in the second area may be determined based on the coordinate information of the points at the corresponding position in the first area, and intensity information of the points in the second area may be determined by the number of points in the first area corresponding to the corresponding points (e.g., the points in the second area). The heat map generation unit 110 may obtain average intensity of the rasterized curves based on the rasterized curves and the second area. Based on the coordinate information of the points on the first curves 701 and the reliability of each of the first curves 701, the heat map generation unit 110 may transform the coordinates of the points on the first curves 701 and coordinates of points in a bounding box into the same coordinate system, using a coordinate transformation matrix, before generating the rasterized curves. The heat map generation unit 110 may set, to a preset value, intensities of the points in the bounding box corresponding to the first curves 701 before generating the rasterized curves, and the intensities may be set based on the coordinate information of the points on the first curves 701 and the reliabilities of the first curves 701.

The first curves 701 may include first-type curves (e.g., polygonal areas) capable of forming a closed area and second-type curves (e.g., dashed lines) other than the first-type curves. The heat map generation unit 110 may generate the first-type heat map 410 by internally filling a portion of the rasterized curves corresponding to the first-type curves. The heat map generation unit 110 may generate a second-type heat map based on a portion of the rasterized curves corresponding to the second-type curves. Before generating the second-type heat map 420, the heat map generation unit 110 may perform normalizing on the average intensity of the rasterized curves for each of the rasterized curves, based on the portion corresponding to the second-type curves. Before normalizing the average intensity of the rasterized curves, the heat map generation unit 110 may perform expansion on the portion corresponding to the second-type curves. The heat map generation unit 110 may expand the portion of the rasterized curves corresponding to the second-type curves. The expansion may be substantially the same as operation 205 described above with reference to FIG. 2. Input data of the heat map generation unit 110 may include a coordinate of a local curve LV, reliability of a local curve LC, a coordinate transformation matrix R, a coordinate transformation vector T, and a bounding box B. An output of the heat map generation unit 110 is a heat map M∈R^{H×W}, in which H and W denote the height and the width of the heat map M, respectively.

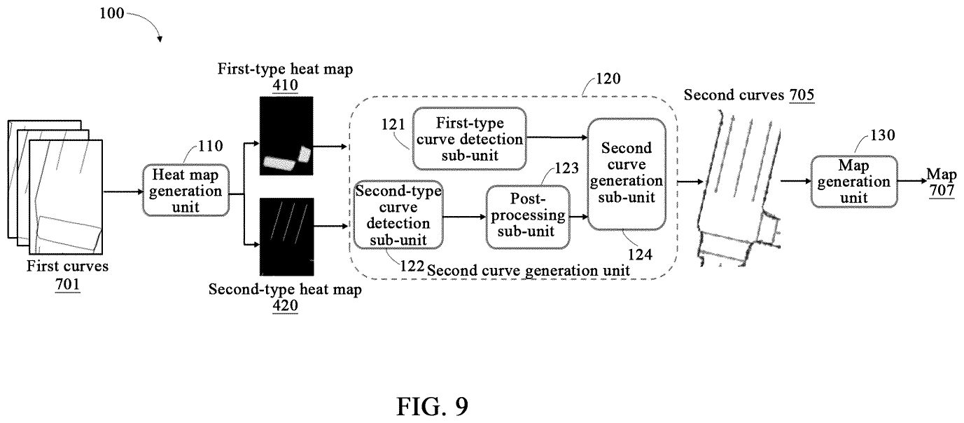

FIG. 9 illustrates an example of a second curve generation unit, according to one or more embodiments.

Referring to FIG. 9, the second curve generation unit 120 of the map-building apparatus 100 may include a first-type curve detection sub-unit 121, a second-type curve detection sub-unit 122, a post-processing sub-unit 123, and a second curve generation sub-unit 124. The first-type curve detection sub-unit 121 may predict first-type curves via a first AI network, based on the first-type heat map 410. The first-type curves may be polygonal areas. The second-type curve detection sub-unit 122 may predict second-type curves via a second AI network, based on the second-type heat map 420. The second-type curves may be dashed lines. The post-processing sub-unit 123 may select at least one second-type curve of the predicted second-type curves, based on the second-type heat map 420, and determine the at least one second-type curve to be a second-type curve of the second curves. The second curve generation sub-unit 124 may generate the second curves 705 based on an output of the post-processing sub-unit 123. For example, the second curve generation sub-unit 124 may obtain the second curves based on the predicted first-type curves and the predicted second-type curves.

The first-type curve detection sub-unit 121 may transform the first-type heat map 410 into a binarized map, using a threshold value, determine connection areas in the binarized map, extract a boundary of each of the connection areas, and determine the boundary to be the first-type curve. The first-type curve detection sub-unit 121 may calculate average reliability of each of the connection areas, normalize the average reliability of each of the connection areas, and obtain the reliabilities of the first-type curves corresponding to the connection areas. The first-type curve detection sub-unit 121 may predict the first-type curves (e.g., the polygonal areas) of the second curves 705 (e.g., the global curves) from the first-type heat map 410. Input data of the first-type curve detection sub-unit 121 may include M, which is the first-type heat map 410. Output data of the first-type curve detection sub-unit 121 may include a coordinate GV and reliability GC of a second curve (e.g., the global curve) in a first type (e.g., a polygonal type). The first-type curve detection sub-unit 121 may normalize the average reliabilities of each of the connection areas, based on the maximum value of the average reliabilities of the connection areas, to normalize the reliability of at least one connection area. The operation performed by the first-type curve detection sub-unit 121 may be substantially the same as operations 501 to 505 described above with reference to FIG. 5.

The second-type curve detection sub-unit 122 may extract a second-type feature from the second-type heat map 420 and predict and obtain coordinate information and reliability of the second-type curve among the second curves, using an AI algorithm, based on the second-type feature. For example, the second-type curve detection sub-unit 122 may extract a dashed line feature from a dashed line-type heat map and predict a coordinate and reliability of the dashed line using a MapTR algorithm. The second-type curve detection sub-unit 122 may predict the second-type curve (e.g., the dashed line) of the second curves 705 (e.g., the global curves) from the second-type heat map 420 (e.g., the dashed line-type heat map). Input data of the second-type curve detection sub-unit 122 may include M, which is the second-type heat map 420. Output data of the second-type curve detection sub-unit 122 may include a coordinate GV′={GV′ₙ∈R^{P}^{ₙ}^{×2}|n=0, 1, N′−1} of the second curve in the second type and reliability GC′∈R^{N′}. Here, N′ denotes the number of second curves in the second type predicted by the second-type curve detection sub-unit 122.

The architecture of the second-type curve detection sub-unit 122 may include a feature extractor, a decoder, a regression header, and a classification header. The feature extractor may extract a feature (e.g., the feature 611 of FIG. 6) from the second-type heat map 420 (e.g., the dashed line-type heat map), using ResNet50+FPN. The operation of the feature extractor may be substantially the same as operation 601 described above with reference to FIG. 6. The decoder (e.g., the decoder 620 of FIG. 6) may predict a coordinate and reliability of the second-type curve (e.g., the dashed line), based on the extracted feature (e.g., the feature 611), using the MapTR algorithm. The map-building apparatus 100 may optimize a predetermined query Q for dashed line prediction, using a decoder (e.g., a MapTR decoder). For example, the decoder (e.g., the MapTR decoder) may include decoder layers that repeatedly updates the query Q. Here, an initial value of the query Q is a portion of a detection parameter obtained through training and may represent common property of the second curve (e.g., the global curve). The decoder may internally perform an operation (e.g., an attention mechanism, a linear operation, and an operation such as SoftMax) between the initial query Q and the feature 611 obtained by feature extraction (e.g., operation 601), continuously optimize the query Q, and finally, output the optimized query Q. The regression header (e.g., the regression header 621 of FIG. 6) may be used to predict coordinates of the second curves 705 from the query Q, using a regression header of the MapTR algorithm. The classification header (e.g., a classification header 625 of FIG. 6) may be used to predict the reliability of the second curves 705 from the query Q, using a single-class classification header of the MapTR algorithm. The operation performed by the second-type curve detection sub-unit 122 may be substantially the same as operations 601 and 602 described above with reference to FIG. 6.

A training dataset used to train a MapTR model may be a heat map. To obtain the training dataset, a NuScenes training dataset may first be input into one MapTR model, and a local curve obtained through inference may be transformed into the heat map using a heat map generator. NuScenes is a large-scale dataset for autonomous vehicles and may include a variety of sensor data. Tasks may be performed separately on each type of local curves, and a total of n (e.g., n may be 1,400) training samples (e.g., training datasets) may be generated. For example, since there are 700 scenarios in the NuScenes training dataset and the number of types of local curves is 2, a lane marking and a road boundary, 700*2=1,400 training samples may be generated. In the training of the MapTR model, when data (e.g., the training dataset) is augmented, a problem of insufficient training data may be alleviated using a data augmentation technique. For example, a data augmentation technique including random transformation, random rotation, and random flipping may be used. When training loss is optimized, the processor 1001 may follow a MapTR model training loss function, which includes three parts, including classification loss [symbol] _{cls}, point-to-point loss [symbol] ₚ₂ₚ, and edge direction loss [symbol] _{dir}. When these loss terms are combined, the overall objective function (i.e., a loss function) may be expressed as follows.

$$ℒ = {λ}_{1} {ℒ}_{cls} + {λ}_{2} {ℒ}_{p 2 p} + {λ}_{3} {ℒ}_{dir}$$

Here, λ₁, λ₂, and λ₃ denote hyperparameters used to balance each loss term.

In the process of training the MapTR model based on the training dataset, an objective function may be minimized by continuously adjusting a parameter of the MapTR model according to changes in the objective function (e.g., the loss function), and finally, a trained MapTR model may be obtained.

The post-processing sub-unit 123 may determine a second-type curve (e.g., a dashed line) of the predicted second-type curves, which has a similarity with the second-type heat map 420 greater than or equal to a threshold value, and update, in the second-type heat map 420 (e.g., the dashed line-type heat map), the second-type heat map 420 such that an intensity value of points corresponding to the determined second-type curve and corresponding points in a set range is set to a preset value. The post-processing sub-unit 123 may continue to determine the second-type curve of the second-type curves having the similarity with the second-type heat map 420 greater than or equal to the threshold value until the second-type curve of the predicted second-type curves of which the similarity with the second-type heat map 420 in the set range does not exist. The determined second-type curve may be the second-type curve of the second curves. Selectively, the post-processing sub-unit 123 may determine the reliability of the second-type curve by normalizing the reliabilities of all the selected second-type curves.

The post-processing sub-unit 123 may perform operations 1 to 6 described below.

In operation 1, the post-processing sub-unit 123 may search for a first dashed line that best matches the second-type heat map 420 of the second-type curves (e.g., the dashed lines) for the predicted second-type curves (e.g., the predicted dashed lines).

In operation 2, the post-processing sub-unit 123 may update the second-type heat map 420 such that an intensity value near the first dashed line becomes 0. For example, in the dashed line-type heat map, the post-processing sub-unit 123 may update a dashed line-type heat map such that an intensity value of points corresponding to the first dashed line and corresponding points in a set range is set to a preset value of 0.

In operation 3, the post-processing sub-unit 123 may add a coordinate and reliability of the first dashed line to a dashed line list.

In operation 4, the post-processing sub-unit 123 may remove the first dashed line from a dashed line portion of the predicted second curves (e.g., the global curves).

In operation 5, the post-processing sub-unit 123 may return to operation 1 and continue operations 1 to 5 until operation the search of operation 1 fails.

In operation 6, when the search for the first dashed line is not possible in operation 1, the post-processing sub-unit 123 may normalize the reliability of all dashed lines in the dashed line list, determine the dashed line in the dashed line list to be a dashed line of the global curves, and determine the normalized reliability to be the reliability of the dashed line of the global curves.

The reliability of a first dashed line may be obtained by calculating the similarity of the first dashed line with the second-type heat map 420. The post-processing sub-unit 123 may select the second-type curve of the second curves more accurately. Input data of the post-processing sub-unit 123 may include the second-type heat map 420 M and the coordinate GV′, which is an output of a dashed line detector, of the second curves 705 (e.g., the global curves). Output data of the post-processing sub-unit 123 may include a final dashed line-type global curve G.

A map-building method and/or a map-building apparatus provided in one or more examples of the present disclosure may transform local curves into a heat map by making high use of input information. The heat map may include a coordinate and reliability information of a global curve to be extracted. The map-building method and/or the map-building apparatus provided in one or more examples of the present disclosure may have high robustness by providing high utilization of the coordinates and reliability information of the plurality of local curves simultaneously. The map-building method and/or the map-building apparatus provided in one or more examples of the present disclosure transforms a global map-building problem into a collective prediction problem and performs prediction based on image detection, using the heat map as an input, so consistency may be ensured for various cases, and the excessive use of a threshold value may be avoided, thereby having excellent versatility.

FIG. 10 illustrates an example of an electronic device, according to one or more embodiments.

Referring to FIG. 10, the electronic device 1000 may include at least one processor (e.g., the processor 1001, in practice, one or more processors of any of the type(s) below, or others). Selectively, the electronic device 1000 may further include a memory 1003 and/or a transceiver 1004 that are coupled with the processor 1001. The electronic device 1000 may be an apparatus (e.g., the map-building apparatus 100) that performs the map-building method 10 described above with reference to FIGS. 1 to 9. The processor 1001 and the memory 1003 may be connected to each other. For example, the processor 1001 and the memory 1003 may be connected to each other via a bus 1002. Selectively, the electronic device 1000 may further include the transceiver 1004. The transceiver 1004 is at least one and may be used for data exchange between the electronic device 1000 and another electronic device. For example, the transceiver 1004 may be used for data exchange such as data transmission and/or data reception. It should be noted that the block diagram of the electronic device 1000 illustrated in FIG. 10 is only an example, and examples are not limited thereto. The electronic device 1000 may be a first network node, a second network node, or a third network node.

The processor 1001 may be a CPU, a general-purpose processor, a digital signal processor (DSP), an application-specific integrated circuit (ASIC), a field programmable gate array (FPGA) or other programmable logic devices, a transistor logic device, a hardware component, or any combination thereof. The processor 1001 may implement or execute examples of various logic blocks, modules, and circuits described herein. The processor 1001 may also be a combination that realizes computing functions, including, for example, a combination of one or more microprocessors or a combination of a DSP and a microprocessor.

The bus 1002 may include a path for transmitting information between components (e.g., the processor 1001, the memory 1003, and the transceiver 1004). The bus 1002 may include a peripheral component interconnect (PCI) bus or an extended industry standard architecture (EISA) bus. The bus 1002 may be divided into an address bus, a data bus, a control bus, and the like. For ease of description, it should be noted that FIG. 10 illustrates the bus 1002 as a single line, but the bus 1002 is not limited to one or only one type.

The memory 1003 may be read-only memory (ROM) or other types of static storage devices capable of storing static information and instructions, random-access memory (RAM) or other types of dynamic storage devices capable of storing information and instructions. The memory 1003 may be electrically erasable programmable read-only memory (EEPROM), a compact disc (CD)-ROM, or another optical disk storage, optical disk storage (including a compressed optical disk, a laser disk, an optical disk, a digital multipurpose disk, a Blu-ray disks, etc.), disk storage media, other magnetic storage devices, or any other computer-readable media that may be used to transport or store a computer program. It should be noted that the memory 1003 is not limited to the examples described herein. The memory 1003 may be used to store a computer program for executing the map-building method 10 and may be controlled by the processor 1001. For example, the memory 1003 may store commands or instructions, and the commands or instructions, when individually or collectively executed by the processor 1001, may cause the electronic device 1000 to implement the map-building method 10.

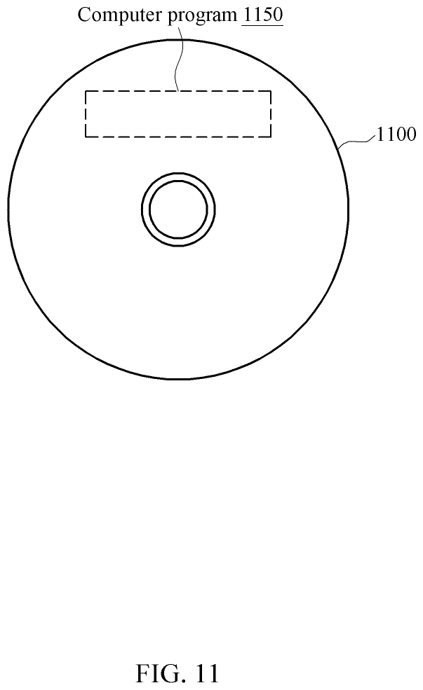

FIG. 11 illustrates an example of a non-transitory computer-readable storage medium, according to one or more embodiments.

Referring to FIG. 11, a non-transitory computer-readable storage medium 1100 (not a signal per se) may store a computer program 1150. The computer program 1150 may be for executing the map-building method 10 described above with reference to FIGS. 1 to 10. The non-transitory computer-readable storage medium 1100 may include a medium in the form of a CD or a digital video disc (DVD). The examples described herein may be implemented using a hardware component, a software component, and/or a combination thereof. For example, a processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For the purpose of simplicity, the description of a processing device is used as singular; however, one skilled in the art will appreciate that a processing device may include multiple processing elements and/or multiple types of processing elements. For example, the processing device may include processors, or a single processor and a single controller. In addition, different processing configurations are possible, such as parallel processors.

The software may include a computer program, a piece of code, instructions, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The computing apparatuses, the electronic devices, the processors, the memories, the sensors, the vehicle/operation function hardware, the displays, the information output system and hardware, the storage devices, and other apparatuses, devices, units, modules, and components described herein with respect to FIGS. 1-11 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of building a map, performed by one or more processors, the method comprising:
generating a heat map based on first curves used to identify a map element of at least one local area, the first curves derived from one or more input frames; and
obtaining second curves using neural network, based on the heat map, the second curves derived from the one or more input frames,
wherein the second curves are used to identify a map element of the map.

2. The method of claim 1, wherein the heat map comprises rasterized curves rasterized from the first curves and the second curves,
wherein the generating of the heat map comprises generating the rasterized curves based on coordinate information of points on the first curves and reliabilities the respective first curves,
wherein coordinate information of points on the rasterized curves is determined based on coordinate information of points corresponding positions on the first curves,
wherein intensity information of the points on the rasterized curves is determined based on positionally-corresponding reliabilities of the first curves.

3. The method of claim 2, wherein the generating of the heat map further comprises:
generating a second area based on coordinate information of points in a first area corresponding to the first curves; and
obtaining an average intensity of the rasterized curves based on the rasterized curves and the second area,
wherein coordinate information of points in the second area is determined based on coordinate information of points at corresponding positions in the first area,
wherein intensity information of the points in the second area is determined based on a number of the points in the first area corresponding to the points in the second area.

4. The method of claim 2, wherein the generating of the rasterized curves comprises setting, to a preset value, intensity information of points in a bounding box corresponding to the first curves.

5. The method of claim 4, wherein the generating of the rasterized curves further comprises transforming coordinates of the points on the first curves and coordinates of the points in the bounding box into a same coordinate system using a coordinate transformation matrix.

6. The method of claim 2, wherein the first curves comprise first-type curves capable of forming closed areas and second-type curves not capable of forming closed areas,
wherein the generating of the heat map comprises generating a first-type heat map by internally filling a portion of the rasterized curves corresponding to the first-type curves.

7. The method of claim 6, wherein the generating of the heat map further comprises generating a second-type heat map based on a portion of the rasterized curves corresponding to the second-type curves.

8. The method of claim 7, wherein the generating of the second-type heat map comprises normalizing average intensities of the rasterized curves.

9. The method of claim 8, wherein the normalizing comprises performing an expansion process on the portion of the rasterized curves corresponding to the second-type curves.

10. The method of claim 7, wherein the obtaining of the second curves comprises:
predicting the first-type curves via a first neural network, based on the first-type heat map;
predicting the second-type curves via a second neural network, based on the second-type heat map; and
obtaining the second curves based on the predicted first-type curves and the predicted second-type curves.

11. The method of claim 10, wherein the obtaining of the second curves further comprises determining at least one of the second curves to be a second-type curve based on the second-type heat map.

12. The method of claim 10, wherein the predicting of the first-type curves via the first neural network, based on the first-type heat map, comprises:
transforming the first-type heat map into a binarized map according to a threshold value;
determining curve-connection areas in the binarized map;
extracting a boundary of each of the curve-connection areas and determining each boundary to be the first-type curves;
calculating average reliabilities of the respective curve-connection areas; and
obtaining reliabilities of the first-type curves corresponding to the curve-connection areas by normalizing the average reliabilities of the curve-connection areas.

13. The method of claim 12, wherein the obtaining of the reliabilities of the first-type curves corresponding to the connection areas by normalizing the average reliabilities of the connection areas comprises normalizing the average reliabilities of the connection areas, based on a maximum value of the average reliabilities of each of the connection areas.

14. The method of claim 10, wherein the predicting of the second-type curves via the second neural network, based on the second-type heat map, comprises:
extracting a second-type feature from the second-type heat map; and
predicting and obtaining, coordinate information and reliabilities of the second-type curves of the second curves based on the second-type feature.

15. The method of claim 11, wherein the determining of the at least one second-type curve of the predicted second-type curves to be the second-type curves in the second curves, based on the second-type heat map, comprises determining at least one second-type curve of the predicted second-type curves, which has a similarity with the second-type heat map in a set range, to be the second-type curves in the second curves.

16. The method of claim 15, wherein the determining of the at least one second-type curve of the predicted second-type curves, which has the similarity with the second-type heat map in the set range, to be the second-type curves in the second curves comprises:
identifying second-type curves of the predicted second-type curves having the similarity with the second-type heat map greater than or equal to a threshold value;
updating the second-type heat map such that an intensity value between a point corresponding to the identified second-type curves in the second-type heat map and a corresponding point in the set range is set to a preset value; and
continuously executing the identifying of the second-type curves of the predicted second-type curves having the similarity with the second-type heat map greater than or equal to the threshold value until the second-type curves of the predicted second-type curves having the similarity with the second-type heat map in the set range are exhausted,
wherein the identified second-type curves are the second-type curves in the second curves.

17. The method of claim 16, further comprising:
determining reliabilities of the second-type curves by normalizing all reliabilities of the identified second-type curves.

18. An electronic device comprising:
one or more processors; and
a memory storing instructions configured to cause the electronic device to implement the method according to claim 1.

19. A non-transitory computer-readable storage medium storing instructions that, when executed by a processor, cause the processor to perform the method of claim 1.
